(19) United States
(12) Patent Application Publication
(10) Pub. No.: US 2015/0076785 A1
(43) Pub. Date: Mar. 19, 2015

(54) HINGED EXTENDABLE CLIMBING AID

(71) Applicant: Manitowoc Crane Group France SAS, Dardilly Cedex (FR)

(72) Inventor: Dennis Kokot, Horsten (DE)

(21) Appl. No.: 14/394,951

(22) PCT Filed: Mar. 15, 2013
(86) PCT No.: PCT/EP2013/055391

§ 371 Date: Oct. 16, 2014

(30) Foreign Application Priority Data
Apr. 18, 2012 (DE) 202012003977.6

(51) Int. Cl. B60R 3/02

(52) U.S. Cl. CPC B60R 3/02
USPC 280/166

(57) ABSTRACT

An extractable fold-down climbing aid for reaching an operator's cab or for climbing onto the walking deck of an undercarriage of a mobile device, for example a mobile crane, includes a stepladder, a holding mechanism in which the stepladder is held for transportation purposes and out of which the stepladder can be moved for use as a climbing aid, a guide for at least one end of the stepladder, which guide is formed by the holding mechanism or is connected to the holding mechanism. The guide and one end of the stepladder together form a joint in which the stepladder can be pivoted relative to the mobile device, and the stepladder is a telescoping stepladder with at least an inner and an outer slide-out element, and the holding mechanism is connected or can be connected to the mobile device.

The invention relates to an extractable fold-down climbing aid for a mobile device, for example a mobile crane, comprising a holding means and a stepladder which can be held in the holding means for transportation purposes and moved out of the holding means for use as a climbing aid. The fold-down climbing aid further comprises a guide for at least one end of the stepladder, and the guide is formed by the holding means or is connected to the holding means. The guide and one end of the stepladder together form a joint in which the stepladder can be pivoted relative to the mobile device. The stepladder is a telescoping stepladder with at least an inner and an outer slide-out element. The holding means is connected or can be connected to the mobile device.

The climbing aids used to date as a means of reaching an operator's cab and/or the walking deck of an undercarriage of a mobile device are usually mounted on one side of the device between the vehicle axles and as a rule are fixedly integrated with the vehicle. Such a climbing aid is known from DE 20 2008 007 872 U1, for example. The stepladder disclosed here is split into parts along the length and the parts can be pivoted relative to one another about hinges and the stepladder itself can be pivoted out from the device about other articulated joints.

Alternatively, hang-in stepladders are known, which are not fixedly connected to the mobile device and are only fitted on the mobile device in particular circumstances, for example when needed. When not in use, they are stowed in any place on the mobile device. DE 10 2005 011 483 A1 discloses a stepladder which can be placed against a motor vehicle and secured on the roof of the vehicle for transportation purposes, for example.

Finally, stepladders based on a swinging design are also known, which are usually fixedly connected to the mobile device and stowed on the walking deck or some other suitable place when the mobile device is travelling. In order to use it, the pivoting stepladder can be pivoted relative to the external face of the device. Such pivoting stepladders are known from U.S. Pat. No. 6,029,775, DE 202009 010 035 U1 and WO 2007/062464 A1.

One objective of the invention is to propose a fold-down climbing aid for a mobile device which is of compact construction and can easily be connected to the mobile device. Another objective is to propose a mobile device having such a fold-down climbing aid.

These objectives are achieved by means of the fold-down climbing aid defined in claim 1 and the mobile device defined in claim 11.

The invention relates to an extractable fold-down climbing aid for reaching an operator's cab or for climbing onto the walking deck of an undercarriage of a mobile device, for example a mobile crane.

The extractable fold-down climbing aid comprises a stepladder and a holding means, and the stepladder is held in the holding means for and during transportation of the mobile device and can be moved out of the holding means for use as a climbing aid. The fold-down climbing aid further comprises a guide for at least one end of the stepladder, which guide is formed by the holding means or a part of the holding means or is connected to the holding means.

The guide and one end of the stepladder together form a joint in which the stepladder can be pivoted relative to the mobile device.

The stepladder is a telescoping stepladder having at least one inner and at least one outer slide-out element. The holding means is connected or can be connected to the mobile device.

The holding means may also be designed as a sort of box in which the stepladder is fully accommodated when the fold-down climbing aid is ready to be mounted on a mobile device. The holding means with the stepladder can then be connected to the device as one piece and when not in use, the stepladder is fully accommodated in the holding means and is moved out of the holding means for use. The holding means box may have a cover which can be closed and preferably locked so that the stepladder is protected against dirt and theft.

Alternatively, the guide may be provided in the form of two U-shaped bars for example, which simultaneously also constitute the holding means for the stepladder. However, the guide may be provided in addition to the holding means and connected to the holding means, for example welded or screwed to it.

The end of the stepladder which forms the joint in conjunction with the guide is preferably retained in the guide in a non-detachable manner. In other words, the stepladder cannot be pulled completely out of the guide and is also connected to the guide in the joint in the extracted state.

To enable a particularly compact construction of the stepladder to be obtained, it is preferable if the at least one inner slide-out element is guided by the rungs of the at least one outer slide-out element as the stepladder is being retracted and extended. In other words, the respective outer slide-out element forms a sort of casing for the respective next inner slide-out element, and the inner faces of the longitudinal sides of the outer slide-out element serve as a guide for the outer faces of the longitudinal sides of the inner slide-out element. At least the rungs of the outer slide-out element form a frame in conjunction with the longitudinal sides, through the opening of which the inner slide-out element can be pushed into the outer slide-out element. Not only can the inner slide-out elements be guided in the respective next outer slide-out element, they can also be retained in a non-detachable manner.

Flat sections or angle sections are used for the longitudinal sides of the stepladder and each rung is formed by two flat sections, one of which constitutes one of the longitudinal sides at the front face of the stepladder whilst the other connects the longitudinal sides to one another at the rear face of the stepladder. If the longitudinal sides are provided in the form of angle sections, for example U-sections or V-sections, it may also be sufficient to dispose the rungs on only the front face of the stepladder, on only the rear face of the stepladder or in an alternating arrangement on the front and rear face of the stepladder. The sections may be steel, aluminium or plastic sections, for example.

In the extracted state, the lowermost rung of the outer slide-out element and the uppermost rung of the inner slide-out element together form one rung of the stepladder. Since the inner slide-out elements are completely accommodated in the next outer slide-out element in the retracted state as mentioned above, the inner slide-out element has one rung less than the directly surrounding outer slide-out element in the extended state.

The stepladder can be pivoted in the joint as far as a stop, for example by an angle of ca. 90°. This means that once it has been moved out of the holding means, the stepladder can be pivoted in the joint so that the user can now use the stepladder to climb into the operator's cab or onto the walking deck of the undercarriage of the mobile device. The mobile device can also be driven on the construction site with the stepladder pivoted down and extended because the stepladder is fixedly connected to the mobile device by the joint and holding means and the point where the holding means is mounted may be selected accordingly. In addition, it may also be of advantage if, for example, the stepladder can be secured in additional retaining elements on the mobile device in the pivoted down and extended state, for example can be clipped in to prevent the stepladder from swinging outwards during travel.

The slide-out elements can be pushed or moved linearly relative to one another but cannot be pivoted relative to one another and instead form a straight stepladder in the extended state.

When the stepladder is in the retracted state held or accommodated in the holding means, it is preferably secured to prevent the stepladder from undesirably extending and/or undesirably moving out from the opening. It may be secured by the cover mentioned above, for example, which in the closed and/or locked state prevents the stepladder from undesirably extending or undesirably moving out of the holding means. Alternatively, a mechanical, hydraulic or electric locking device may be provided, which has to be released by the user before he can move the stepladder out of the holding means, for example. The stepladder can be unlocked by hand or by pushing a button provided to hand, by a portable remote control or a system that can be operated from the driver's cab, for example. A display may also be provided in the driver's cab which indicates to the driver that the stepladder is not secured in the holding means when the vehicle is started. This being the case, it would also be conceivable to provide a start-up lock because if the stepladder were to extend during travel, this could pose a significant risk to traffic.

Although it is preferable for the stepladder to be manually moved and extended by the user, it would also be possible to provide the extractable fold-down climbing aid with a drive unit by means of which the stepladder can be at least partially moved out of the holding means and then gripped, pivoted and extended by the user. The fold-down climbing aid may also be moved out of the holding means, extended and pivoted on a fully automated basis and moved back into the holding means in the reverse sequence. In this respect, it is irrelevant whether the stepladder is firstly extended and then pivoted or firstly pivoted and then extended once it has been moved out of the holding means.

The holding means for the stepladder may be mounted on the mobile device in such a way that it is disposed entirely underneath the operator's cab or walking deck of the undercarriage. When the stepladder is fully accommodated in the holding means, the stepladder is preferably also concealed entirely underneath the operator's cab or walking deck. In other words, neither the stepladder nor the holding means juts out beyond an edge of the operator's cab or walking deck of the undercarriage. This prevents the risk of an accident and thus increases operating safety. It also imparts an attractive appearance to the travelling or parked mobile device, which is not marred by a visible fold-down climbing aid.

Another advantage resides in the fact that there are no contours of a fold-down climbing aid placed on the walking deck or outside the cab which could be disruptive and risk collision with other elements typically used on cranes, for example, such as rear storage boxes, counterweights accommodated on the rotary table and/or undercarriage, or other elements rotating about the centre of rotation, such as slewing gears, rotary encoders, pinion guard, etc. Providing the fixed mounting point for the holding means with the stepladder saves on the need to fetch the stepladder from somewhere else on the vehicle and carry it to the climbing aid point.

The invention also relates to a mobile device with an operator's cab and/or a walking deck with a fold-down climbing aid of the type defined in the previous pages. The fold-down climbing aid may be connected to the mobile device at any point underneath the operator's cab and/or underneath the walking deck. It is preferable if the extended ladder does not extend as far as the floor because in this case, the mobile device can be moved on the deployment site without having to move the fold-down climbing aid into the stowed position beforehand.

A more detailed explanation of a fold-down climbing aid proposed by the invention will be given below with reference to the appended drawings. However, the invention is not restricted to the embodiment illustrated as an example. Features which are essential to the invention and can only be seen in the drawings may be used individually and at least in the illustrated combinations to impart advantageous features to the subject matter.

The drawings specifically illustrate the following:

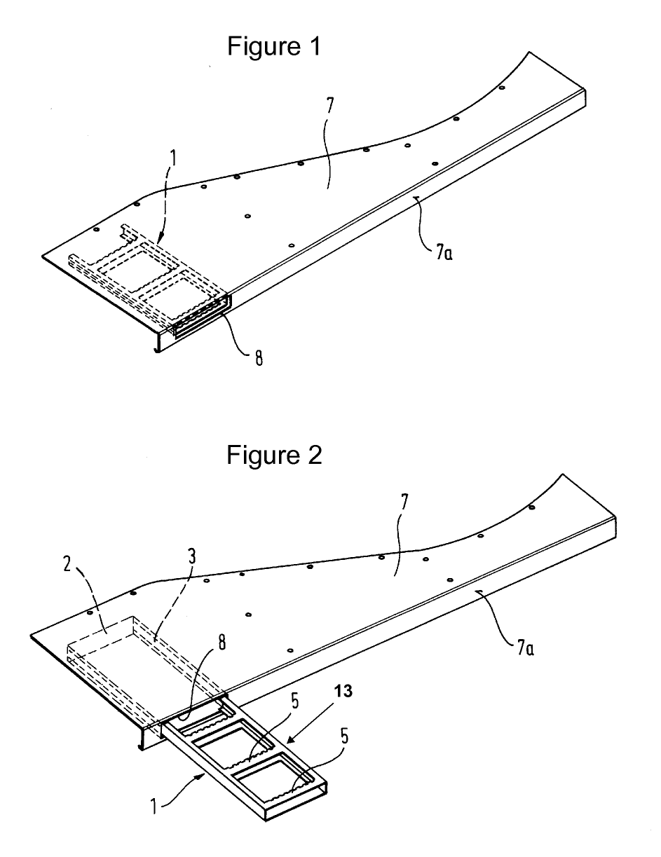

FIG. 1 a walking deck seen from above with a fold-down climbing aid disposed underneath it

FIG. 2 a fold-down climbing aid extending out from the walking deck

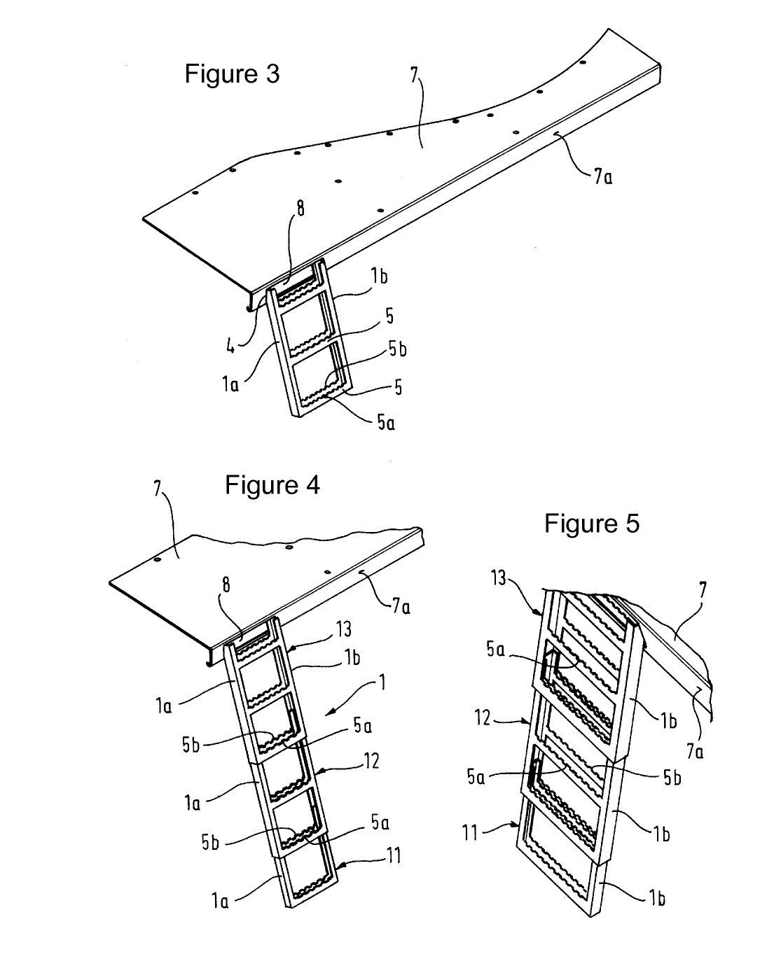

FIG. 3 a fold-down climbing aid after having been pivoted

FIG. 4 a fold-down climbing aid with an extended stepladder

FIG. 5 a view of an extended stepladder on a larger scale.

FIG. 1 illustrates a part of a walking deck 7 of a mobile device. As indicated by broken lines, the stepladder 1 accommodated in a holding means 2, not illustrated, is disposed underneath the walking deck 7. As may be seen, there is an opening 8 in the downwardly bent front face 7a of the walking deck 7, which can be closed by means of a cover, for example. The stepladder 1 can be moved through the opening 8 out of the holding means 2.

FIG. 2 now illustrates the stepladder 1 moved out of the holding means 2, which is indicated by broken lines in this instance. The holding means 2 or longitudinal sides of the holding means 2 simultaneously serve as a guide 3 for the stepladder 1. The stepladder 1 can be pulled out of the holding means 2 by hand by the user or, alternatively, the fold-down climbing aid may have a drive, although this is not illustrated, by means of which the stepladder 1 can be moved into the illustrated position.

FIG. 2 shows the outermost slide-out element 13 with three rungs 5. As may also be seen, the rungs 5 are made from flat sections 5a, 5b which in conjunction with the longitudinal sides 1 a, 1 b of the stepladder 1 form a frame. The flat sections 5a, 5b have profiling on their top face to give the shoe sole a reliable hold during climbing. In the embodiment illustrated as an example, this takes the form of notches which prevent the shoe from slipping sideways on the rung 5.

In FIG. 3, the stepladder 1 is illustrated in a position pivoted against the downwardly bent front face 7a of the walking deck 7. To this end, the guide 3 and one end of the stepladder 1 together form a joint 4 about which the stepladder 1 can be pivoted. In the embodiment illustrated as an example, a part of the downwardly bent front face 7a of the walking deck 7 acts as a stop to restrict the pivoting movement of the stepladder 1. Alternatively, the guide 3 may incorporate the stop for restricting the pivoting movement of the stepladder 1 in its end facing the downwardly bent front face 7a.

FIGS. 4 and 5 illustrate the extended stepladder 1. In the embodiment illustrated as an example, the stepladder 1 has three slide-out elements: an outermost slide-out element 13, a middle slide-out element 12 and an innermost slide-out element 11. The middle slide-out element 12 constitutes the next inner slide-out element for the outermost slide-out element 13 and simultaneously the next outer slide-out element for the innermost slide-out element 11.

Accordingly, as may be seen from FIG. 5 in particular, the next inner slide-out element 11, 12 is guided and retained in the next outer slide-out element 12, 13.

As may clearly be seen from FIG. 4, the width and the depth of the individual slide-out elements 11, 12, 13 differs. This is a result of the fact that the respectively inner slide-out element 11, 12 constitutes a slide-in means for the respectively outer slide-out element 12, 13. In other words, slide-out element 11 can be pushed in slide-out element 12 until the two bottom faces of the respectively lowermost rungs 5 of slide-out element 11 and slide-out element 12 lie in at least one plane and slide-out element 12 can be pushed into slide-out element 13 until all three bottom ends of the respectively lowermost rungs 5 lie at least in one plane. “Lie at least in one plane” in this context should be understood as meaning that the respectively inner slide-out elements 11, 12 can also be pushed farther into the respective outer slide-out elements 12, 13.

When the stepladder 1 is fully retracted, the external dimension of the outermost slide-out element 13 corresponds to the external dimension of the retracted stepladder 1.

FIGS. 4 and 5 also very graphically illustrate the compact construction of the fold-down climbing aid based on the stepladder 1. In the retracted state, the stepladder 1 in this example of an embodiment has three rungs 5. If slide-out element 13 and slide-out element 12 were connected by a fold-out hinge, the stepladder would have a maximum of five rungs for the same length when folded open. The length of the stepladder folded in would be greater than the length of the telescoping stepladder 1. If the stepladder 1 were a fold-out ladder based on a rotating design, it would have only three, maximum four, rungs for the same length. The telescoping stepladder 1 in the embodiment illustrated as an example, however, has six rungs 5, thereby offering a gain of at least one rung 5 for the same length and a reduced height and thus a gain in comfort for the user.

### LIST OF REFERENCE NUMBERS

1 Stepladder
1a Longitudinal side
1b Longitudinal side
2 Holding means
3 Guide
4 Hinge
5 Rung
5a Flat section
5b Flat section
6 Stop
7 Walking deck
7a Downwardly bent front face
8 Opening
11 Slide-out element
12 Slide-out element
13 Slide-out element

1. An extractable fold-down climbing aid for reaching an operator's cab or for climbing onto the walking deck of an undercarriage of a mobile device, for example a mobile crane, comprising
a stepladder;
a holding mechanism configured to hold the stepladder for transportation purposes and out of which the stepladder can be moved for use as a climbing aid;
a guide for at least one end of the stepladder, which guide is at least one of formed by the holding mechanism and connected to the holding mechanism; and
wherein the guide and the at least one end of the stepladder together form a joint in which the stepladder can be pivoted relative to the mobile device; and,
the stepladder is a telescoping stepladder with at least one inner slide-out element and at least one outer slide-out element; and,
the holding mechanism is at least on of connected and connectable to the mobile device.

2. The extractable fold-down climbing aid as claimed in claim 1, wherein the at least one inner slide-out element is configured to be guided by at least one rung of the at least one outer slide-out element when the stepladder is being retracted and extended.

3. The extractable fold-down climbing aid as claimed in claim 1, wherein the stepladder is configured to be pivoted in the joint as far as a stop.

4. The extractable fold-down climbing aid as claimed in claim 1, wherein the at least one inner slide-out elements and at least one out slide out element of the stepladder are connected to one another in a non-detachable manner and are secured to prevent at least one of undesired extension and undesired movement out of the holding mechanism when the at least one inner slide-out element and the at least one outer-slide out element are in at least a retracted state.

5. The extractable fold-down climbing aid as claimed in claim 4, wherein the at least one inner slide-out element is configured to be at least one of guided in the at least one outer slide-out element and retained in the at least one outer-slide out element in a non-detachable manner.

6. The extractable fold-down climbing aid as claimed in claim 1, wherein the at least inner slide-out element has one rung less than the at least one slide-out element when the stepladder is extended.

7. The extractable fold-down climbing aid as claimed in claim 4, wherein an uppermost rung of the at least one inner slide-out element forms a common rung in conjunction with a lowermost rung of the at least one outer slide-out element.

8. The extractable fold-down climbing aid as claimed in claim 1, wherein the at least one inner slide-out element and at least one outer slide-out elements cannot be pivoted relative to one another.

9. The extractable fold-down climbing aid as claimed in claim one, wherein the fold-down climbing aid has a drive unit configured to at least partially move the stepladder out of the holding mechanism.

10. The extractable fold-down climbing aid as claimed in claim 1, wherein the holding mechanism is disposed entirely underneath at least one of the operator's cab and the walking deck of the undercarriage so that when the stepladder is fully accommodated in the holding mechanism neither the holding mechanism nor the stepladder juts out beyond an edge of at least one of the operator's cab and the walking deck of the undercarriage.

11. A mobile device with at least one of an undercarriage and an operator's cab, comprising an extractable fold-down climbing aid, that includes:
a stepladder;
a holding mechanism configured to hold the stepladder for transportation purposes and out of which the stepladder can be moved for use as a climbing aid;
a guide for at least one end of the stepladder, which guide is at least one of formed by the holding mechanism and connected to the holding mechanism; and
wherein the guide and the at least one end of the stepladder together form a joint in which the stepladder can be pivoted relative to the mobile device; and,
the stepladder is a telescoping stepladder with at least one inner slide-out element and at least one outer slide-out element; and,
the holding mechanism is at least on of connected and connectable to the mobile device; and,
wherein the fold-down climbing aid is disposed at any point underneath at least one of the operator's cab and a walking deck of the undercarriage.

12. The extractable fold-down climbing aid as claimed in claim 5, wherein the at least one inner slide-out element comprises a plurality of inner slide-out elements, and wherein at least one of the plurality of inner slide-out elements is configured to be at least one of guided and retained in at least another of the plurality of inner slide-out elements in the manner that one of the plurality of inner slide-out elements is configured to be at least one of guided and retained in the at least one outer slide-out element.
